(19) United States
(12) Patent Application Publication
(10) Pub. No.: US 2018/0082241 A1
(43) Pub. Date: Mar. 22, 2018

(54) PROCESSING RECORDS BY COMBINING VISUALFORCE AND QUEUEABLES TECHNOLOGIES IN THE SALESFORCE PLATFORM

(71) Applicant: FinancialForce.com, Inc., San Francisco, CA (US)

(72) Inventors: Stephen Paul Willcock, Harrogate (GB); Bradley West Slater, Leeds (GB); Matthew David Wood, Leeds (GB); Carolina Ruiz, Harrogate (GB)

(21) Appl. No.: 15/271,191

(22) Filed: Sep. 20, 2016

(51) Int. Cl. G06Q 10/06

(52) U.S. Cl. CPC G06Q 10/063118; G06Q 10/0633

(57) ABSTRACT

Disclosed embodiments include a method combining VISUALFORCE and QUEUEABLES on a SALESFORCE platform to process jobs. The method can include, by a VISUALFORCE processing page, processing a job identifier for a job, routing the identified job to a QUEUEABLE configured to process the identified job, and adding a QUEUEABLE identifier for the QUEUEABLE to a QUEUEABLES list. The method can also include, by a VISUALFORCE polling page, polling the QUEUEABLES list for the QUEUEABLE identifier, determining that the QUEUEABLE has been processed based on the QUEUEABLES list, and obtaining records by the processing of the QUEUEABLE.

### TECHNICAL FIELD

The disclosed teachings generally relate to systems and methods for data processing. The disclosed teachings more particularly relate to systems and methods for combining VISUALFORCE® and QUEUEABLE technologies to allow for processing large volumes of records in the SALESFORCE® platform.

### BACKGROUND

Cloud platforms such as the SALESFORCE platform allow for sharing processing resources and data in a multi-tenant network that offers computing services on-demand to customers. More generally, cloud computing enables ubiquitous, on-demand access to a shared pool of configurable computing resources (e.g., networks, servers, storage, applications, and services), which can be rapidly provisioned and released with minimal management effort. The SALESFORCE platform may provide numerous companies with an environment to deploy applications that provide an interface for case management and task management, and a system for automatically handling events.

The SALESFORCE platform can facilitate processing millions, hundreds of millions, or even billions of records while optimizing the performance of data loads and integration into a company's services. However, cloud-based platforms that provide multi-tenant processing impose limits in an effort to uniformly distribute access to resources, which creates an ever present issue for customers that work with large volumes of data. For example, the SALESFORCE platform imposes governor limits that create an issue for customers seeking to process large volumes of data in a reasonable period of time. In particular, certain contexts in the SALESFORCE platform may limit retrieving no more than 50,000 data records (“records”) per request. As such, twenty separate and sequential requests would be required to retrieve 1,000,000 data records. Thus, any process or approach that would allow for efficiently processing large volumes of records (e.g., greater than 50,000) is valuable in cloud-based platforms such as the SALESFORCE platform.

### SUMMARY

Introduced herein is a technique that can include at least one method and at least one system. The at least one method is for combining a method combining VISUALFORCE and QUEUEABLES on a SALESFORCE platform to process jobs. The method can include, by a VISUALFORCE processing page, processing a job identifier for a job, routing the identified job to a QUEUEABLE configured to process the identified job, and adding a QUEUEABLE identifier for the QUEUEABLE to a QUEUEABLES list. The method can also include, by a VISUALFORCE polling page, polling the QUEUEABLES list for the QUEUEABLE identifier, determining that the QUEUEABLE has been processed based on the QUEUEABLES list, and obtaining records by the processing of the QUEUEABLE.

In some embodiments, a computer-implemented method performed in a cloud-based platform can include processing a job identifier obtained from a job list to obtain an identified job, where the job list includes job identifiers associated with jobs. The method can include routing the identified job to a queued object configured to process the identified job, and adding a queued-object identifier for the queued object to a queued-objects list. The method can further include polling the queued-objects list for the queued-object identifier of the queued object, determining that the queued object has been processed based on the queued-objects list, and obtaining at least some of a plurality of records based on the processed queued object.

The at least one system can be a computer system operative to combine VISUALFORCE and QUEUEABLES on a SALESFORCE platform to process records. In some embodiments, the computer system can include a processor and a memory that includes instructions that, when executed by the processor, cause the computer system to, by a VISUALFORCE processing page, process a job identifier for a job, route the identified job to a QUEUEABLE configured to process the identified job, and add a QUEUEABLE identifier for the QUEUEABLE to a QUEUEABLES list. The computer system also can be operative to, by a VISUALFORCE polling page, poll the QUEUEABLES list for the QUEUEABLE identifier, determine that the QUEUEABLE has been processed based on the QUEUEABLES list, and obtain records by the processing of the QUEUEABLE.

Other aspects of the disclosed embodiments will be apparent from the accompanying figures and Detailed Description.

This Summary is provided to introduce a selection of concepts in a simplified form that are further explained in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of a system that can combine VISUALFORCE and QUEUEABLES on a SALESFORCE platform to process large volumes of records according to some embodiments of the present disclosure;

FIG. 2 is a block diagram illustrating a comparison of VISUALFORCE and QUEUEABLE technologies combined according to some embodiments of the present disclosure;

FIG. 3 is a flowchart illustrating a process for combining VISUALFORCE and QUEUEABLE technologies to process large volumes of records according to some embodiments of the present disclosure;

FIG. 4 is a flowchart illustrating a method for processing jobs in a cloud-based platform according to some embodiments of the present disclosure;

FIG. 5 is a flowchart illustrating a method for monitoring queued objects configured to process jobs in a cloud-based platform according to some embodiments of the present disclosure; and

FIG. 6 is a block diagram illustrating a computing device that is operable to implement the disclosed technology according to some embodiments of the present disclosure.

### DETAILED DESCRIPTION

The embodiments set forth below represent the necessary information to enable those skilled in the art to practice the embodiments, and they illustrate the best mode of practicing the embodiments. Upon reading the following description in light of the accompanying figures, those skilled in the art will understand the concepts of the disclosure and will recognize applications of these concepts that are not particularly addressed here. It should be understood that these concepts and applications fall within the scope of the disclosure and the accompanying claims.

The purpose of terminology used herein is only for describing embodiments and is not intended to limit the scope of the disclosure. Where context permits, words using the singular or plural form may also include the plural or singular form, respectively.

As used herein, unless specifically stated otherwise, terms such as “processing,” “computing,” “calculating,” “determining,” “displaying,” “generating,” or the like, refer to actions and processes of a computer or similar electronic computing device that manipulates and transforms data represented as physical (electronic) quantities within the computer's memory or registers into other data similarly represented as physical quantities within the computer's memory, registers, or other such storage medium, transmission, or display devices.

As used herein, terms such as “connected,” “coupled,” or the like, refer to any connection or coupling, either direct or indirect, between two or more elements. The coupling or connection between the elements can be physical, logical, or a combination thereof.

Processing large volumes of records requires a complex scalable computing infrastructure that is cost-prohibitive to many businesses. As such, businesses turn to cloud computing to use a shared pool of configurable computing resources that provide scalable services for many applications. An example of a cloud-based platform includes the SALESFORCE platform.

Although the SALESFORCE platform can process moderate volumes of records, it imposes governor limits that create an issue for customers seeking to efficiently process large volumes of records. For example, in some contexts, the SALESFORCE platform limits access to no more than 50,000 records per request, which requires making multiple requests to retrieve a total of 1,000,000 data records, which limits the efficiency of retrieving the records.

The disclosed technique overcomes the aforementioned drawbacks because it allows for efficiently processing large volumes of records (e.g., greater than 50,000) on the SALESFORCE platform. In some embodiments, features of VISUALFORCE and QUEUEABLES are combined to process the volumes of records. For example, a task that involves processing the records can be broken down into jobs. A VISUALFORCE processing page processes job identifiers, routes jobs to QUEUEABLES configured to process the jobs, and adds identifiers for the QUEUEABLES to a QUEUEABLES list. The QUEUEABLES are asynchronously processed as an arrangement of interconnected branches of a single process. A VISUALFORCE polling page can poll the QUEUEABLES list for the statuses of the QUEUEABLES, and obtain records of any processed QUEUEABLES, which can be combined as the results of the completed task.

VISUALFORCE is a component-based user interface (UI) framework for the FORCE.COM platform of the SALESFORCE platform. The framework includes a tag-based markup language, similar to HTML. Each VISUALFORCE tag corresponds to a coarse or fine-grained UI component, such as a section of a page, or a field. Thus, VISUALFORCE can be used to create entire custom pages on the SALESFORCE platform for an organization, in conjunction with many other front-end technologies, such as HTMLS, CSS3 and JavaScript. VISUALFORCE tightly couples to native features of the SALESFORCE platform, such as controller methods and data access that typically would not be available to other front end technologies.

VISUALFORCE includes a read-only mode that can be set for an entire page. The read-only mode can be enabled for the page by setting a read-only attribute of the page to true. The read-only mode specifically provides for custom reporting and analytics. Normally, queries for a single VISUALFORCE page request cannot retrieve more than 50,000 data records. However, in read-only mode, this limit is relaxed to allow querying up to 1,000,000 data records. Hence, enabling read-only mode for a VISUALFORCE page is advantageous because it allows for querying a greater number of records.

A downside to the use of VISUALFORCE in read-only mode to query records is the limited availability of resources for processing the data records. Moreover, results obtained using VISUALFORCE in read-only mode cannot be saved. Thus, controllers for VISUALFORCE pages using the read-only attribute can query up to 1,000,000 records but cannot save data as records, attachments, etc., and are limited by CPU processing time (e.g., 10 seconds) and memory heap allocation (e.g., 6 MB).

A QUEUEABLE is an example of a queuing technology of the SALESFORCE platform. A QUEUEABLE is an asynchronous process that can be queued for execution (e.g., a queued object). For example, after a job is submitted for execution, the job can be added to a QUEUEABLE and will be processed when system resources become available. In contrast to VISUALFORCE, QUEUEABLES have more generous resource allocation limitations for processing data compared to the read-only mode for VISUALFORCE. In particular, QUEUEABLES are limited to querying only 50,000 records for processing but can use up to 60 seconds of CPU time and 12 MB of heap allocation. QUEUEABLES also provide the ability to save records.

A QUEUEABLE can be associated with an identifier that is unique from another identifier associated with another QUEUEABLE. The identifiers can be used to monitor the statuses of the jobs associated with the QUEUEABLES. For example, a QUEUEABLES interface can enable access by developers to add jobs to QUEUEABLES and monitor the statuses of those jobs. Each status can be monitored programmatically by querying the QUEUEABLE or through the UI. QUEUEABLES can run asynchronously to process jobs. Hence, processes that run for a long time can be run asynchronously by adding jobs to QUEUEABLES. An asynchronous QUEUEABLE can run in the background in its own thread and does not delay the execution of other logic. As indicated above, a benefit of using QUEUEABLES is that some governor limits may be greater compared to other processes available for the SALESFORCE platform.

In some embodiments, QUEUEABLES can be chained. Specifically, a QUEUEABLE is chained when the QUEUEABLE can be started from a running QUEUEABLE. Typically, only one QUEUEABLE can exist for each parent QUEUEABLE at any time. There may be no limit on the depth of chained QUEUEABLES. As such, a QUEUEABLE can be chained to another QUEUEABLE, and this process can repeat with each child QUEUEABLE linked to a new child. Note, however, that chaining QUEUEABLES is different from arranging QUEUEABLES in branches because, for example, the former does not require a child QUEUEABLE to start from a running parent.

The disclosed embodiments can combine the read-only mode of VISUALFORCE with QUEUEABLES so that 1,000,000 records can be read and processed for reporting purposes, despite the limits of VISUALFORCE, by using QUEUEABLES. Specifically, the VISUALFORCE read-only mode controller is used to query for specified data. The data retrieved as a result of the query is passed to a QUEUEABLE, which runs asynchronously, to leverage the larger CPU and heap limits of QUEUEABLES compared to VISUALFORCE. In some embodiments, the retrieved data can either be raw records obtained via the query or the results of an aggregate query.

As such, the disclosed embodiments overcome the drawbacks of either context (VISUALFORCE or QUEUEABLES) while leveraging each of their advantages to provide a solution that can query 1,000,000 records, process these records using 60 seconds of CPU time and 12 MB of heap, and allow for saving the output of this process. Hence, the disclosed embodiments can achieve significant gains in processing large volumes of records (e.g., greater than 50,000) compared to existing technologies.

The disclosed technique can be described in the context of a billing services add-on application on the SALESFORCE platform because such services typically require processing large volumes of records. However, the disclosed technique has broad applicability to process large volumes of data for any cloud-based services. Further, the disclosed technique could facilitate processing any amount of data to increase throughput and provide useful insights and outputs.

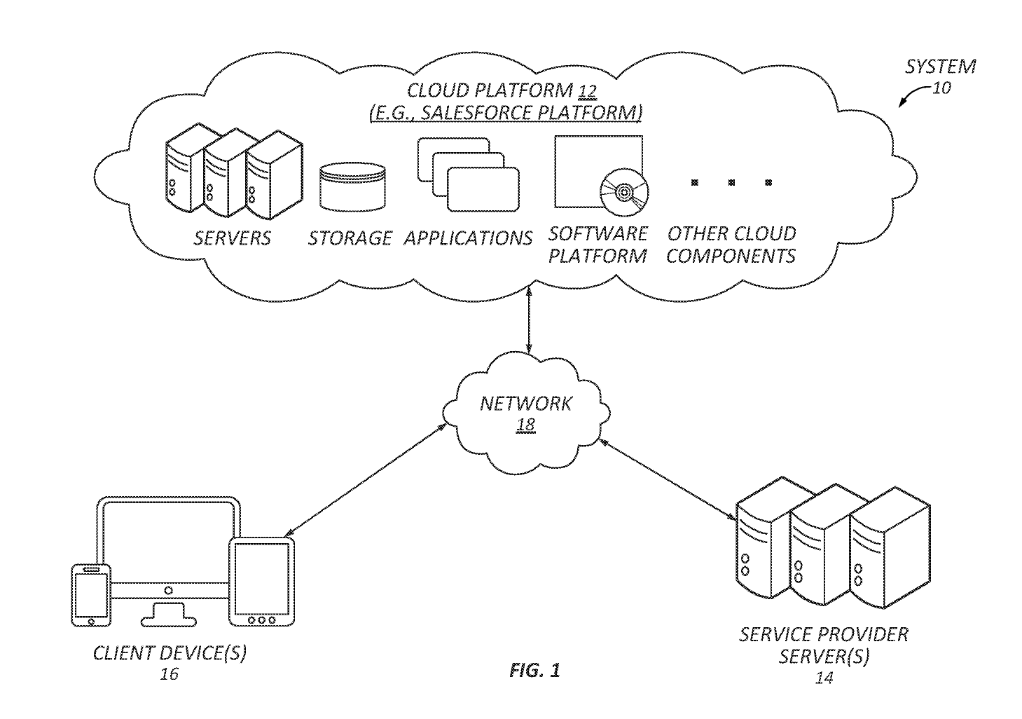

FIG. 1 is a block diagram of a system that can combine VISUALFORCE and QUEUEABLES on a SALESFORCE platform to process large volumes of records according to some embodiments of the present disclosure. The system 10 includes components, such as a cloud platform 12 (e.g., the SALESFORCE platform), one or more service provider servers 14 that use cloud-based services to provide add-on applications, and one or more client devices 16 that use the add-on applications, all of which are interconnected over a network 18 such as the Internet, to provide processing of a large volume of data.

The network 18 may include any combination of private, public, wired, or wireless portions. Data communicated over the network 18 may be encrypted or unencrypted at various locations or along different portions of the network 18. Each component of the system 10 may include combinations of hardware and/or software to process data, perform functions, communicate over the network 18, and the like. For example, any component of the system 10 may include a processor, memory or storage, a network transceiver, a display, an operating system (OS), application software (e.g., for providing a user portal), and the like. Other components, hardware, and/or software included in the system 10 are well known to persons skilled in the art and, as such, are not shown or discussed herein.

The cloud platform 12 can provide access to a shared pool of configurable computing resources, including servers, storage, applications, a software platform, networks, services, and the like, accessed by the service provider servers 14 to offer add-on applications to the client devices 16. The cloud platform 12 (e.g., the SALESFORCE platform) supports multiple tenants and may be referred to as a platform as a service (PaaS).

The PaaS is provided to developers for creating the add-on applications that run on the components of the cloud platform 12. FORCE.COM is an example of a PaaS that hosts applications hosted on the SALESFORCE platform, which is an example of a cloud platform. For example, add-on applications can provide subscription billing services to users using the client devices 16. The subscription billing services are provided by the service provider servers 14 and include applications built on the software platform of the cloud platform 12.

The service provider servers 14 may include any number of server computers that provide the add-on applications such as subscription billing services, which allow businesses to automatically bill their customers for goods or services on a pre-arranged schedule. The billing services may support installment payments, usage-based billing, and multiple charging methods. Although shown separately from the cloud platform 12, the service provider servers 14 may be included in the cloud platform 12.

The service provider servers 14 may provide or administer a UI (e.g., website) accessible from the client devices 16. The UI may include features such as dashboard analytics to provide insight into how a business is performing. Examples of businesses that could benefit from subscription billing services range from SaaS providers to energy and utilities companies.

The add-on applications provided by the service provider servers 14 are built using a particular programming language. For example, FORCE.COM applications are built using APEX (a proprietary Java-like programming language for FORCE.COM) and VISUALFORCE (an XML syntax typically used to generate HTML). The code used to build applications may include functions that are accessible by the add-on applications.

The add-on applications can process volumes of data generated by businesses. For example, the service provider servers 14 can provide subscription billing services that process volumes of billing data generated by businesses that have a large number of customers that are billed routinely for ongoing services. The data may include sales agreements, usage, and pricing, which are used to generate sales invoices to bill customers. As such, voluminous amounts of data are generated continuously.

In an effort to accommodate multiple tenants (e.g., multiple service providers), the cloud platform 12 may restrict the number of concurrent processes available to users. For example, the SALESFORCE platform limits users to a few concurrent processes at any time, which not only limits throughput to process large volumes of data, but can also interfere with other processes concurrently running in the background.

Currently, resorting to using a BATCH process is the only way to query across 1,000,000 records on the SALESFORCE platform, and save the resulting data for reuse. A BATCH is an asynchronous process provided by the SALESFORCE platform to process large volumes of data in batches. A developer can employ a BATCH to build complex, long-running processes that operate on thousands of records. A BATCH can operate over an entire record broken down into manageable chunks of data.

A BATCH process can be programmatically invoked at runtime using code of the SALESFORCE platform. However, the code limits the number of BATCHES that are possible at any one time. As such, BATCH allows the service provider servers 14 to process large volumes of data, but subjects the processing to constraints that limit throughput. More specifically, the BATCH API of the SALESFORCE platform is an interface limited to five queued or active BATCHES at one time. As such, users are constrained by a current count of BATCHES before initiating any new ones.

Existing subscription billing services may implement a BATCH to process large volumes of records. However, a BATCH process has limited throughput. For example, processing 1,000,000 records with a single BATCH would require several hours because a single batch process can only process a fraction of that amount.

Even if multiple BATCHES were run concurrently, using all available BATCH slots may interfere with background processes such that processing 1,000,000 records in an hour is not possible. In other words, a target volume may be achieved in less time when using multiple concurrent BATCH slots, but this may interfere with other processes such that BATCH processes are forced to wait. Moreover, concurrent BATCH slots cannot accommodate processing an ongoing production of records of varying volumes at a target rate. Thus, BATCH processes do not provide acceptable throughput, which is critical for maintaining operations when voluminous amounts of data is generated continuously.

The disclosed technique overcomes these drawbacks. For example, the disclosed technique can query and process much more data without resorting to using a BATCH process. The disclosed technique may include combining VISUALFORCE and QUEUEABLES to process volumes of records. A VISUALFORCE processing page can trigger the creation of QUEUEABLES to process identified jobs, and add corresponding identifiers to a list. A VISUALFORCE polling page can poll the list for statuses of QUEUEABLES, and obtain records of any processed QUEUEABLES. The data contained in the records can be combined, and visualized on a display or reported. As a result, the SALESFORCE platform can process large volumes of records (e.g., greater than 50,000) in an efficient manner despite governor limits and without resorting to BATCH processes.

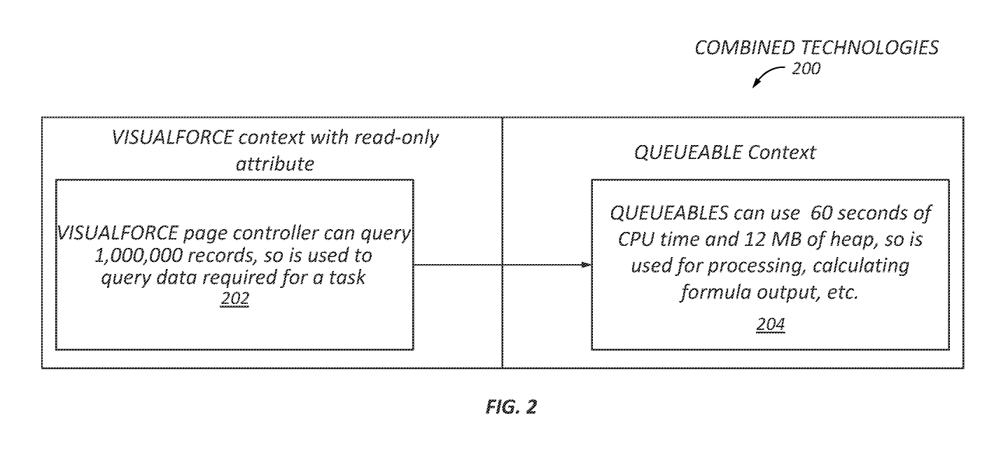

FIG. 2 is a block diagram illustrating a comparison of VISUALFORCE and QUEUEABLE technologies combined according to some embodiments of the disclosure. As shown, VISUALFORCE and QUEUEABLE are different contexts in a SALESFORCE environment that can be combined 200 to achieve greater throughput.

The VISUALFORCE context 202 can have a read-only attribute set to increase the number of records that may be queried. That is, queries for a single VISUALFORCE page request cannot retrieve more than 50,000 data records; however, in read-only mode, this limit is relaxed to allow querying up to 1,000,000 data records. Hence, enabling read-only mode for a VISUALFORCE page is advantageous because it allows for querying a greater number of records for a task. The downside of using VISUALFORCE context 202 as a standard context for processing the records is that controllers for VISUALFORCE cannot save data as records and have limited availability of computing resources (e.g., 10 seconds of CPU processing time and 6 MB of heap).

The QUEUEABLES context 204, on the other hand, can use 60 seconds of CPU time and 12 MB of heap. As such, VISUALFORCE controllers can be used to query data required for a task, and QUEUEABLES can be used for processing, calculating, formula output, or the like. For example, a VISUALFORCE page can process identified jobs of records, trigger the creation of QUEUEABLES to process the jobs, and add identifiers of the QUEUEABLES to a QUEUEABLES list. The QUEUEABLES can be processed asynchronously until all the jobs have been completed. Another VISUALFORCE page can monitor the QUEUEABLES list for the status of each identified QUEUEABLES. The records obtained by processing the jobs as QUEUEABLES can be obtained and reported.

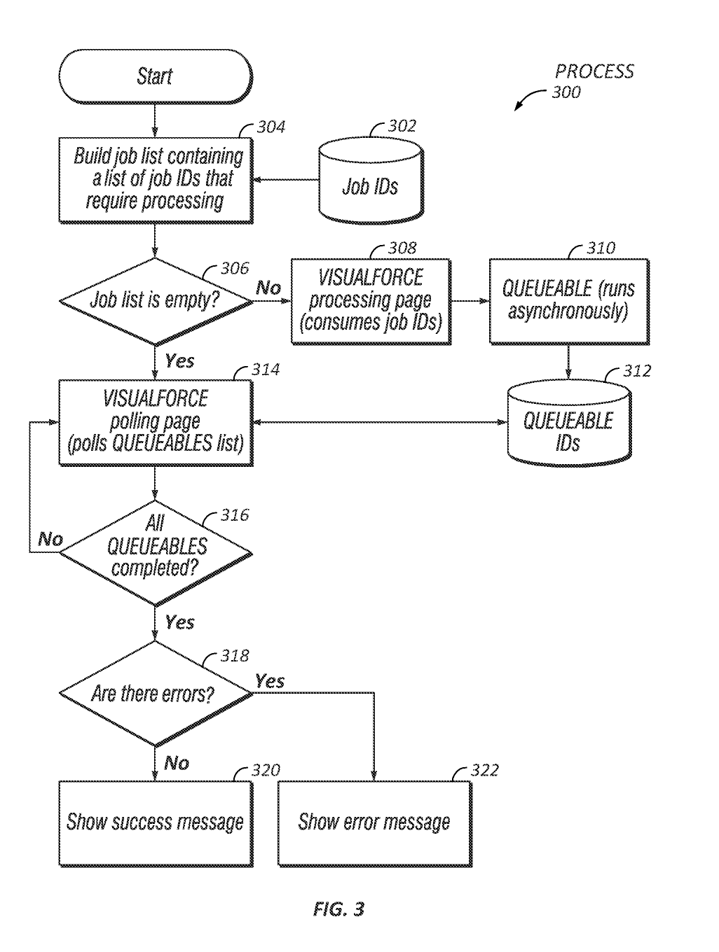

FIG. 3 is a flowchart illustrating a process for combining VISUALFORCE and QUEUEABLE technologies to process large volumes of records according to some embodiments of the present disclosure. In step 302, job identifiers are created or obtained based on information included in a database. For example, the information may include records or jobs of records. The job identifiers can be unique to distinguish between jobs of the same task. In step 304, a job list is built identifying a list of jobs that require processing. For example, an add-on billing application of a SALESFORCE platform can process a query received for billing records. The process may involve 1,000,000 records that can be broken up into jobs with identifiers that are used to build the job list.

The job list can be used to monitor the status of the job identifiers. For example, the job list may only include job identifiers that have not been processed. Accordingly, in step 306, the job list is checked for any remaining job identifiers. In step 308, a VISUALFORCE processing page can iteratively consume any job identifiers remaining on the job list. In step 310, the VISUALFORCE processing page can route job information related to each job identifier on the job list to a QUEUEABLE configured to process the job.

In step 312, the VISUALFORCE processing page adds an identifier for each QUEUEABLE to a QUEUEABLES list. In some embodiments, the QUEUEABLES list may include a status indicator for each QUEUEABLE, which can indicate whether a QUEUEABLE has been processed. In some embodiments, the QUEUEABLES list may only include identifiers of QUEUEABLES that have not been processed.

In step 314, a VISUALFORCE polling page iteratively polls the QUEUEABLES list to determine the status of the QUEUEABLES. For example, the VISUALFORCE polling page may determine if there are any remaining QUEUEABLES identified on the QUEUEABLES list that have yet to be processed.

In step 316, the VISUALFORCE polling page continues polling the QUEUEABLES list until all the QUEUEABLES on the list have been processed. Any records obtained by processing the QUEUEABLES may be combined as results in response to the query. For example, resulting records may be combined and reported on a spreadsheet or can be further analyzed to produce charts or graphs based on the records.

In step 318, the SALESFORCE platform can check for any errors that occurred while performing any of the aforementioned steps of the process 300. In step 320, a success message may issue if no errors occurred while processing the jobs or there are no errors in the results. In step 322, on the other hand, an error message may issue if errors were encountered while processing the jobs or there are errors in the results. For example, the SALESFORCE platform could check whether any errors occurred while processing the QUEUEABLES and issue a message for display on a UI to indicate whether any errors occurred.

As such, the disclosed technique includes a routing mechanism that allows for chaining together a number of jobs as part of an umbrella process, and joining the resulting chunks of processed data together into a single report. In order to perform the process multiple times, and wait for the results to be obtained (because QUEUEABLES are asynchronous), the disclosed technique implements the routing process to carry out the required work and then waits for it to complete.

In some embodiments, since the technique uses VISUALFORCE pages, the routing can be via UI page redirect functions. Moreover, any or all of the aforementioned steps of process 300 may be performed when one or both of the VISUALFORCE processing page or the VISUALFORCE polling page are in read-only mode.

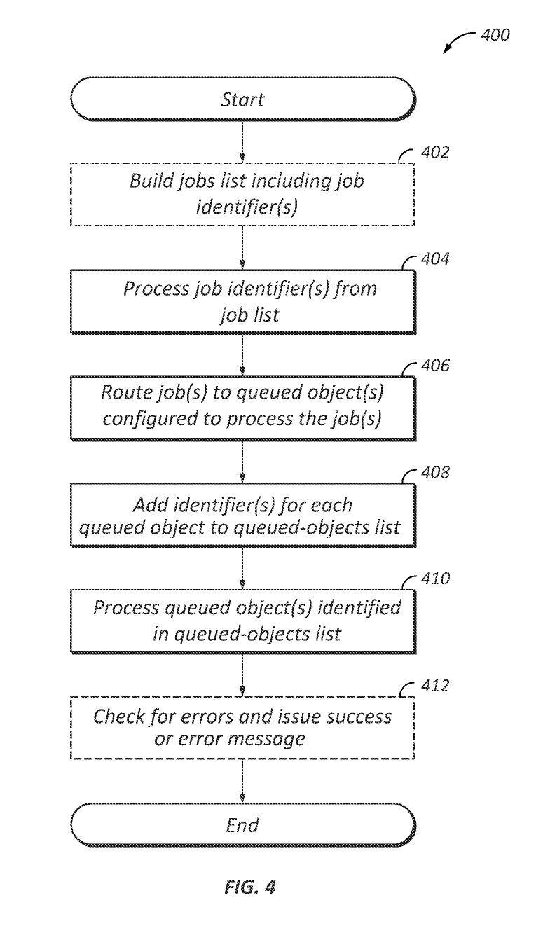

FIG. 4 is a flowchart illustrating a method for processing jobs in a cloud-based platform according to some embodiments of the present disclosure. In particular, the method 400 combines a component-based UI framework (e.g., VISUALFORCE page) and queued objects (e.g., QUEUEABLES) to process jobs.

In step 402, the cloud-based platform (e.g., SALESFORCE platform) can build a job list including job identifiers associated with jobs. In some embodiments, the jobs may belong to a single task created in response to a query involving a volume of records. As such, each job can correspond to at least some of the volume of records.

In some embodiments, a first instance of the component-based UI framework (e.g., in read-only mode) may iteratively consume the job identifiers to route jobs to queued objects and update a list of queued objects. In step 404, the first instance of the component-based UI framework processes each job identifier from the job list. In step 406, the first instance of the component-based UI framework routes job information for each identified job to a queued object configured to process each job. Then, in step 408, the first instance of the component-based UI framework adds a queued-object identifier for each queued object to a queued-objects list.

In step 410, the queued objects are processed to obtain data records. The queued objects may be processed independently of each other under the control of the first instance of the component-based UI framework. The queued objects may form branches of a single process including the jobs used to obtain the volume of records. Moreover, the queued objects may be processed asynchronously. The records obtained by processing the queued objects may form a final output in response to the query.

In step 412, the cloud-based platform may determine whether errors occurred while performing any of the steps of the method 400. Upon determining that no errors occurred, a success message may issue. Upon determining that an error occurred, on the other hand, an error message may issue. For example, the cloud-based platform could check whether any errors occurred while processing the queued objects. Then, a message can be displayed on a UI to indicate whether any errors occurred.

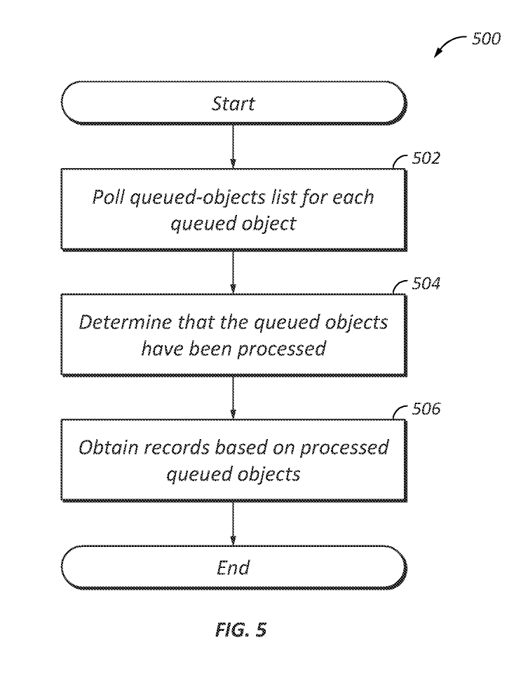

FIG. 5 is a flowchart illustrating a method 500 for monitoring queued objects configured to process jobs in a cloud-based platform according to some embodiments of the present disclosure. In some embodiments, a second instance of the component-based UI framework (e.g., in read-only mode) can be used to iteratively monitor the queued objects, obtain records from processed queued objects, and combine those records to obtain a final output. As such, the second instance of the component-based UI framework can join the results of processing individual queued objects into a single output (e.g., report).

In step 502, the second instance of the component-based UI framework can poll the queued-objects list to determine the status of each queued object. For example, the queued-objects list may include status information for each queued object, indicative of whether the queued object has been processed. As such, the queued-objects list can be used to monitor whether the processing of queued objects is pending or completed.

In some embodiments, the second instance of the component-based UI framework may begin polling after the first instance of the component-based UI framework has processed all the job identifiers (e.g., after the jobs are queued), and terminate after all the jobs have been completed by (e.g., after the queued objects are complete).

In step 504, the second instance of the component-based UI framework can determine whether the queued objects have been processed, based on, for example, the status of each queued object or based on identifiers remaining on the queued-objects list. Then, in step 506, the second instance of the component-based UI framework can obtain any or all the records of the processed queued objects, combine those records, and report the combined result in response to the query.

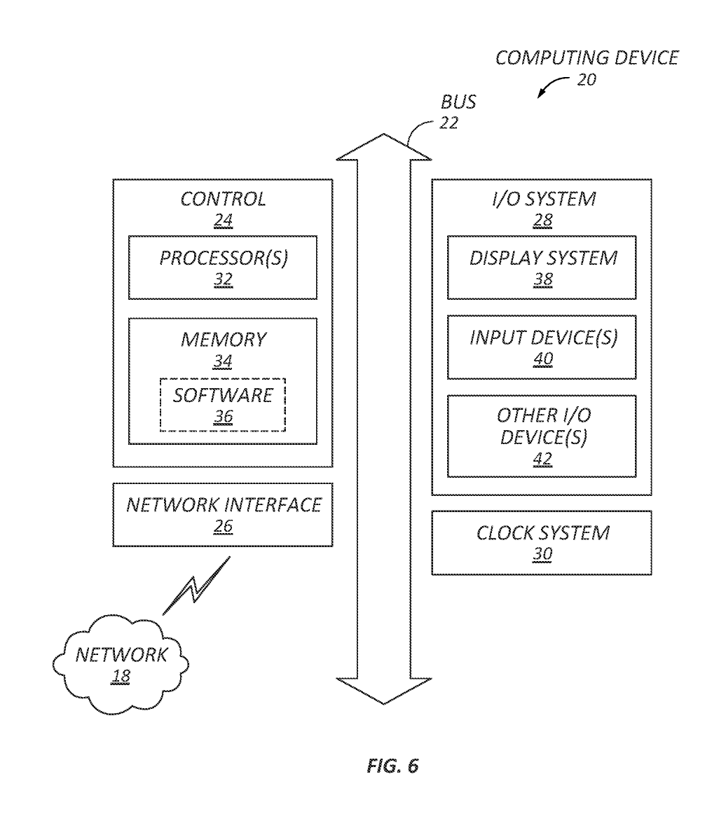

FIG. 6 is a block diagram illustrating a computing device that is operable to implement the disclosed technology according to some embodiments of the present disclosure. As shown, a computing device 20 includes a bus 22 that is operable to transfer data between hardware components. These components include a control 24 (e.g., processing system), a network interface 26, an input/output (I/O) system 28, and a clock system 30. The computing device 20 may include other components that are not shown nor further discussed for the sake of brevity. One having ordinary skill in the art will understand any hardware and software that is included but not shown in FIG. 6.

The control 24 includes one or more processors 32 (e.g., central processing units (CPUs), application-specific integrated circuits (ASICs), and/or field programmable gate arrays (FPGAs)), and memory 34 (which may include software 36). For example, the memory 34 may include volatile memory (e.g., RAM) and/or non-volatile memory (e.g., read-only memory (ROM)). The memory 34 can be local, remote, or distributed.

A software program (e.g., software 36), when referred to as “implemented in a computer-readable storage medium,” includes computer-readable instructions stored in the memory (e.g., memory 34). A processor (e.g., processor 32) is “configured to execute a software program” when at least one value associated with the software program is stored in a register that is readable by the processor. In some embodiments, routines executed to implement the disclosed embodiments may be implemented as part of OS software (e.g., MICROSOFT® WINDOWS® and LINUX®) or a specific software application, component, program, object, module, or sequence of instructions referred to as “computer programs.”

As such, the computer programs typically comprise one or more instructions set at various times in various memory devices of a computer (e.g., computing device 20), which, when read and executed by at least one processor (e.g., processor 32), will cause the computer to perform operations to execute features involving the various aspects of the disclosed embodiments. In some embodiments, a carrier containing the aforementioned computer program product is provided. The carrier is one of an electronic signal, an optical signal, a radio signal, or a non-transitory computer-readable storage medium (e.g., memory 34).

The network interface 26 may include a modem or other interfaces (not shown) for coupling the computing device 20 to other computers over the network 18. The I/O system 28 may operate to control various other I/O devices 42, including peripheral devices such as a display system 38 (e.g., a monitor or touch-sensitive display), and one or more input devices 40 (e.g., a keyboard and/or pointing device). Other I/O devices 42 may include, for example, a disk drive, printer, scanner, or the like. Lastly, the clock system 30 controls a timer for use by the disclosed embodiments.

Operation of a memory device (e.g., memory 34), such as a change in state from a binary one (1) to a binary zero (0) (or vice versa), may comprise a visually perceptible physical change or transformation. The transformation may comprise a physical transformation of an article to a different state or thing. For example, a change in state may involve an accumulation and storage of charge or a release of stored charge. Likewise, a change of state may comprise a physical change or transformation in magnetic orientation or a physical change or transformation in molecular structure, such as a change from crystalline to amorphous or vice versa.

Aspects of the disclosed embodiments may be described in terms of algorithms and symbolic representations of operations on data bits stored in memory. These algorithmic descriptions and symbolic representations generally include a sequence of operations leading to a desired result. The operations require physical manipulations of physical quantities. Usually, though not necessarily, these quantities take the form of electric or magnetic signals that are capable of being stored, transferred, combined, compared, and otherwise manipulated. Customarily, and for convenience, these signals are referred to as bits, values, elements, symbols, characters, terms, numbers, or the like. These and similar terms are associated with physical quantities and are merely convenient labels applied to these quantities.

While embodiments have been described in the context of fully functioning computers, those skilled in the art will appreciate that the various embodiments are capable of being distributed as a program product in a variety of forms and that the disclosure applies equally, regardless of the particular type of machine or computer-readable media used to actually effect the embodiments.

While the disclosure has been described in terms of several embodiments, those skilled in the art will recognize that the disclosure is not limited to the embodiments described herein and can be practiced with modifications and alterations within the spirit and scope of the invention. Those skilled in the art will also recognize improvements to the embodiments of the present disclosure. All such improvements are considered within the scope of the concepts disclosed herein. Thus, the description is to be regarded as illustrative instead of limiting.

1. A computer-implemented method combining VISUALFORCE and QUEUEABLES on a SALESFORCE application development platform to process a plurality of jobs, the method comprising:
processing, by a VISUALFORCE processing page, a job identifier for a job;
routing, by the VISUALFORCE processing page, the identified job to a QUEUEABLE configured to process the identified job;
adding, by the VISUALFORCE processing page, a QUEUEABLE identifier for the QUEUEABLE to a QUEUEABLES list;
polling, by a VISUALFORCE polling page, the QUEUEABLES list for the QUEUEABLE identifier;
determining, by the VISUALFORCE polling page, that the QUEUEABLE has been processed based on the QUEUEABLES list; and
obtaining, by the VISUALFORCE polling page, at least some of a plurality of records by the processing of the QUEUEABLE.

2. The method of claim 1, wherein at least one of the VISUALFORCE processing page or the VISUALFORCE polling page is in read-only mode.

3. The method of claim 2 further comprising, prior to processing the job identifier:
building a jobs list including the plurality of job identifiers associated with the plurality of jobs that require processing, the plurality of job identifiers including the job identifier.

4. The method of claim 3, wherein the VISUALFORCE processing page iteratively processes each job identifier, routes a job of each job identifier to a QUEUEABLE configured to process the job, and adds a QUEUEABLE identifier for each QUEUEABLE to the QUEUEABLES list.

5. The method of claim 4, wherein polling the QUEUEABLES list by the VISUALFORCE polling page begins after all jobs have been routed to the QUEUEABLES.

6. The method of claim 5, wherein obtaining at least some of the plurality of records comprises:
determining, by the VISUALFORCE polling page, that each of the QUEUEABLES has been processed; and
combining, by the VISUALFORCE polling page, records obtained by the processed QUEUEABLES to thereby obtain the plurality of records.

7. The method of claim 6 further comprising, upon determining that the QUEUEABLES have been processed:
checking for errors related to processing the QUEUEABLES;
upon detecting an error, issuing an error message; and
upon detecting no errors, issuing a success message.

8. A computer-implemented method performed on a cloud-based platform, the method comprising:
processing a job identifier obtained from a job list to obtain an identified job, the job list including a plurality of job identifiers associated with a plurality of jobs;
routing the identified job to a queued object configured to process the identified job;
adding a queued-object identifier for the queued object to a queued-objects list;
polling the queued-objects list for the queued-object identifier of the queued object;
determining that the queued object has been processed based on the queued-objects list; and
obtaining at least some of a plurality of records based on the processed queued object.

9. The method of claim 8 further comprising, prior to processing the job identifier:
building the jobs list of the plurality of job identifiers including the job identifier.

10. The method of claim 8 further comprising, upon determining that the queued objects have been processed:
checking for errors related to processing the queued objects;
upon detecting an error, issuing an error message; and
upon detecting no errors, issuing a success message.

11. The method of claim 8, wherein the cloud-based platform iteratively processes each job identifier, routes each job of each job identifier to a queued object configured to process the job, and adds a queued-object identifier for each queued object to the queued-objects list.

12. The method of claim 11, wherein polling the queued-objects list begins after all the jobs have been routed to the queued objects.

13. The method of claim 12, wherein obtaining at least some of the plurality of records comprises:
determining that each of the queued objects has been processed; and
combining records obtained based on the processed queued objects to thereby obtain the plurality of records.

14. The method of claim 8, wherein:
processing the job identifier, routing the identified job, and adding the queued-object identifier to the queued-objects list is performed by a first instance of a component-based user interface framework; and
polling the queued-objects list, determining that the queued object has been processed, and obtaining the plurality of records is performed by a second instance of a component-based user interface framework.

15. The method of claim 14, wherein the cloud-based platform is a SALESFORCE platform, the first instance of a component-based user interface framework is a first VISUALFORCE page in read-only mode, and the second instance of a the component-based user interface framework is a second VISUALFORCE page in read-only mode, and the queued object is a QUEUEABLE.

16. The method of claim 8, wherein the queued objects are processed asynchronously.

17. A computer system for combining VISUALFORCE and QUEUEABLES on a SALESFORCE application development platform to process a plurality of records, the computer system comprising:
a processor; and
a memory that includes instructions that, when executed by the processor, cause the computer system to:
process, by a VISUALFORCE processing page, a job identifier for a job;
route, by the VISUALFORCE processing page, the identified job to a QUEUEABLE configured to process the identified job;
add, by the VISUALFORCE processing page, a QUEUEABLE identifier for the QUEUEABLE to a QUEUEABLES list;
poll, by a VISUALFORCE polling page, the QUEUEABLES list for the QUEUEABLE identifier;
determine, by the VISUALFORCE polling page, that the QUEUEABLE has been processed based on the QUEUEABLES list; and
obtain, by the VISUALFORCE polling page, at least some of a plurality of records by the processing of the QUEUEABLE.

18. The method of claim 17, wherein at least one of the VISUALFORCE processing page is in read-only mode or the VISUALFORCE polling page is in read-only mode.

19. The computer system of claim 18 being further operative to:
iteratively process each job identifier, route a job of each job identifier to a QUEUEABLE configured to process the job, and add a QUEUEABLE identifier for each QUEUEABLE to the QUEUEABLES list.

20. The computer system of claim 19 being further operative to:
determine that each of the QUEUEABLES has been processed; and
combine records obtained by the processed QUEUEABLES to thereby obtain the plurality of records.
